(19) United States
(12) Patent Application Publication
(10) Pub. No.: US 2020/0404014 A1
(43) Pub. Date: Dec. 24, 2020

(54) INDUSTRIAL SECURITY LIFECYCLE MANAGEMENT HUB SYSTEM

(71) Applicant: Siemens Energy, Inc., Orlando, FL (US)

(72) Inventors: Leandro Pfleger de Aguiar, Robbinsville, NJ (US); Gary Murphy, Brunswick, NJ (US); Matthew Stewart, Arlington, VA (US)

(21) Appl. No.: 16/762,969

(22) PCT Filed: Aug. 29, 2018
(86) PCT No.: PCT/US2018/048424

§ 371 Date: May 11, 2020

Related U.S. Application Data
(60) Provisional application No. 62/587,655, filed on Nov. 17, 2017.

(51) Int. Cl. H04L 29/06; G05B 19/05; G06F 21/57

(52) U.S. Cl. CPC H04L 63/1433; H04L 63/1408; G06F 21/577; G05B 19/05

(57) ABSTRACT

A system (100, 400) and method is provided for industrial security lifecycle management that includes at least one multi-app sensor (110). Based on a plurality of received configuration profiles (136), the multi-app sensor may be configured to execute respectively a plurality of applications (108) from different security providers, which applications monitor and collect data from at least one control system (120) in at least one industrial network (138) and from at least one virtual model (134) of the control system. Such a control system may include at least one programmable logic controller (PLC). Based on comparisons between collected data from the control system and the virtual model, the multi-app sensor may generate at least further configuration profile that provides further detection coverage for control system anomalies, and the multi-app sensor may deploy the further configuration profile to further multi-app sensors.

### CROSS REFERENCE TO RELATED APPLICATIONS

This application claims benefit of U.S. Provisional Application No. 62/587,655 filed on Nov. 17, 2017, which application is hereby incorporated herein by reference in its entirety.

### TECHNICAL FIELD

The present disclosure is directed, in general, to industrial security.

### BACKGROUND

Security systems may be used to protect industrial processes and equipment. Such systems may benefit from improvements.

### SUMMARY

Variously disclosed embodiments include data processing systems and methods that may be used to facilitate an industrial security lifecycle management hub system. In one example, a system may comprise at least one multi-app sensor comprising at least one processor configured via executable instructions included in at least one memory to cause the multi-app sensor to carry out several functions. For example, the multi-app sensor may, based on a plurality of received configuration profiles, execute respectively a plurality of applications from different security providers. The applications may monitor and collect data from at least one control system in at least one industrial network and from at least one virtual model of the control system. The control system may include at least one programmable logic controller (PLC). Based on comparisons between collected data from the control system and the virtual model, the multi-app sensor may generate at least one further configuration profile that provides further detection coverage for control system anomalies. The multi-app sensor may also deploy the further configuration profile to further multi-app sensors.

In another example, a method for carrying out industrial security lifecycle management may comprise acts carried out through operation of at least one processor that correspond to the functions for which the previously described multi-app sensor is configured to carry out.

A further example may include a non-transitory computer readable medium encoded with executable instructions (such as a software component on a storage device) that when executed, causes at least one processor to carry out this described method.

Another example may include a product or apparatus including at least one hardware, software, and/or firmware based processor, computer, component, controller, means, module, and/or unit configured for carrying out functionality corresponding to this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates industrial security lifecycle management.

FIGS. 2-3 illustrate block diagrams of example deployments of security management tools.

FIG. 4 illustrates a block diagram of an industrial security lifecycle management hub system.

FIGS. 5 and 6 illustrate block diagrams of example models and analysis that may be carried out by the described system.

FIG. 7 illustrates a flow diagram of an example methodology that facilitates industrial security lifecycle management.

FIG. 8 illustrates a block diagram of a data processing system in which an embodiment may be implemented.

### DETAILED DESCRIPTION

Various technologies that pertain to systems and methods that facilitate industrial security lifecycle management will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be appreciated that industrial control systems may include various components such as controllers, HMIs, programmable logic controllers (PLCs) and other operations technology that are configured in an industrial network arrangement to carry out industrial processes. Management of security risks in an industrial network is often carried out using ad-hoc and disconnected manual processes and technology. Different tools are used for different asset types and security provider vendors and there is a lack of an effective approach to manage the security processes associated with these assets. Examples of such security processes include: Industrial asset management; industrial asset configurations management; industrial asset change management; industrial security event and incident management; vulnerability and patch management; risk management; and industrial asset availability and performance management.

Risk assessment tools developed with the focus on industrial control systems may be ineffective at automatically correlating risks to asset information collected autonomously from control systems (e.g., Siemens SPPA T3000 and SIMATIC PCS7). Follow-up on risk reduction efforts may be performed manually. But, changes in the environment may not trigger automatic risk profile review; hence, with such changes there is a likelihood of inaccurate understanding of current risk levels. Also, external information related to asset vulnerabilities and new attack vectors is not effectively correlated automatically to existing plant asset information to trigger an immediate risk level increase action and immediate action. Further, existing customer portal solutions deployed by MSSPs (managed security service providers) may not be effective at covering particularities of the manufacturing environment (e.g., security relevant industrial data is not collected and uploaded automatically to centralized security operations centers).

Emerging intrusion detection and anomaly detection with a focus on industrial assets have been created recently and with increasing coverage of additional processes. These technologies (provided by companies such as Darktrace, Sentryo, Industrial Defender) make use of deep-packet inspection software and hardware engines to detect industrial assets communicating in the network and monitor for security anomalies. However, these techniques do not provide the holistic coverage for all the necessary security processes that asset owners deal with daily to control their risks in a complex deployment with multiple network appliances by different security provider vendors scattered with highly customized configurations for each plant and plant network zone.

Deploying a new technology with a proven capacity to detect new types of attacks is often cost prohibitive, given the associated effort, impact (given the need of production outages for such updates), and time needed. In addition, existing security management tools are often ineffective at contextualizing security information and anomalies with the current status of the production process, leading to a number of false positives that demand attention from already small and busy OT security teams. In particular, there is a lack of correlation (for the purpose of security monitoring) between the status of critical process variables and security events.

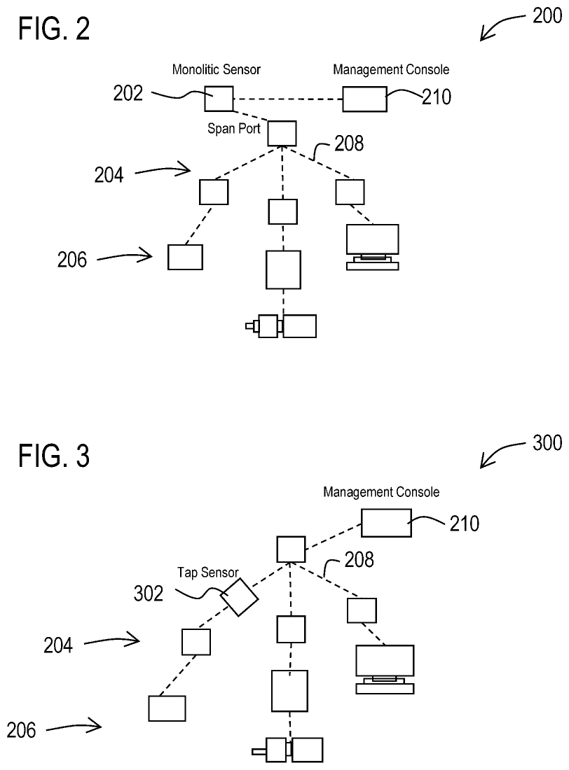

For example, approaches for deploying such security management tools may correspond to that shown in FIGS. 2 and 3. For both passive and active data monitoring modes, monolithic sensors 202, 302 are deployed either in a “span” (port mirroring) topology 200 (FIG. 2) or a “tap” topology 300 (FIG. 3). These sensors 202, 302 report the security status of a plurality of different devices (e.g., control systems 204 including PLCs, configured to control/monitor industrial components and equipment 206 on an industrial network 208) and network to a central management console 210. Both approaches suffer from the following disadvantages:
1. Multiple sensors are needed for each security management process/vendor (e.g., one sensor for anomaly detection, one sensor for configurations management, one sensor for vulnerability scanning/management);
2. Replacing a given security provider means replacing all the sensors;
3. The deployment of such architecture has the potential to increase the attack surface as both the sensors and the management console acts as regular assets connected to the network;
4. These sensors might also be the target of DoS attacks, as these are perceptible in the network;
5. There is no control of the overall overhead caused by such sensors in the network during execution for the active type of sensors; and
6. Process control data is processed separately by production management systems (not used for contextualization of the security data).

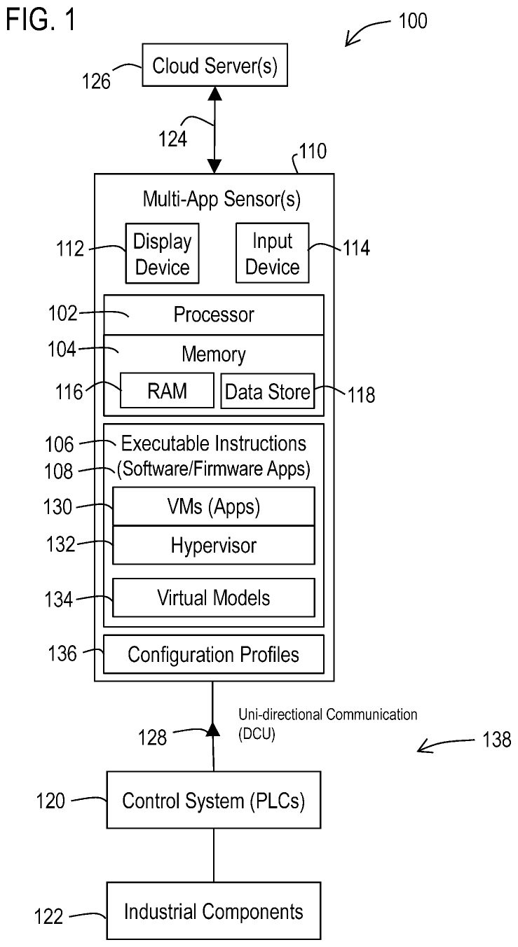

FIG. 1 illustrated an example embodiment of an industrial security lifecycle management (ISLM) hub system 100 that solves the above-mentioned gaps. Such an ISLM hub system may provide an open platform for multi-party/vendor security provider applications and an ecosystem management infrastructure: to allow application configuration and security data to be exchanged; to enable benchmarking of different security providers; and to automatically generate and deploy further configuration profiles (e.g., virtual patches) to improve security.

The system employs one or more data processing systems 110 referred to herein as multi-app sensors that securely monitor at least one control system 120 (which includes at least one PLC) on an industrial network 138. Each multi-app sensor may comprise at least one processor 102 (e.g., a microprocessor/CPU). The processor 102 may be configured to carry out various processes and functions described herein by executing from a memory 104, computer/processor executable instructions 106 corresponding to one or more software and/or firmware applications 108 or portions thereof that are programmed to cause the at least one processor to carry out the various processes and functions described herein.

Such a memory 104 may correspond to an internal or external volatile or nonvolatile processor memory 116 (e.g., main memory, RAM, and/or CPU cache), that is included in the processor and/or in operative connection with the processor. Such a memory may also correspond to non-transitory nonvolatile data stores 118 (e.g., flash drive, SSD, hard drive, ROM, EPROMs, optical discs/drives, databases, or other non-transitory computer readable media) in operative connection with the processor.

The described multi-app sensor 110 may optionally include at least one display device 112 and at least one input device 114 in operative connection with the processor. The display device, for example, may include an LCD or AMOLED display screen, monitor, VR head set, projector, or any other type of display device capable of displaying outputs from the processor. The input device, for example, may include a mouse, keyboard, touch screen, touch pad, trackball, buttons, keypad, game controller, gamepad, camera, microphone, motion sensing devices that capture motion gestures, or other type of input device capable of providing user inputs to the processor.

The multi-app sensor 110 may be configured to execute a plurality of applications 108 (referred to herein as apps) that monitor and collect data from the control system 120 and associated industrial components and systems 122. Collected data may be communicated over an overlay monitoring network 124, to one or more cloud servers 126. In some example embodiments an embedded store-and-forward feature of the multi-app sensor 110 may be used to collect and forward the collected data from the apps.

Such an overlay monitoring network 124 may extend across multiple customers, multiple customer's sites/plants, and multiple network zones within each plant. The multi-app sensor may be configured to operate in a uni-directional mode only using a uni-directional gateway (data diode) 128 or an internal firewall. All data collected by the multi-app sensor 110 may be aggregated in multiple levels in a multi-tenant environment by passive and active apps operating in the multi-app sensor. In example embodiments such apps may be configured to operation in different virtual machines 130 operating on a hypervisor 132 or other virtual machine environment or other type of virtualization system (such as apps operating in dockers or other containers in a containerization system). Also, it should be appreciated that the apps operating on the multi-app sensor 110 may be from different security providers (e.g., parties/vendors). Also, as will be explained in more detail below, the multi-app sensor 110 may operate a virtual model 134 of the physical control system 120. Comparisons between data collected from the virtual model and the physical control system may be used to detect anomalies and derive profiles for detecting anomalies via other multi-app sensors across the overlay network.

In example embodiments, the apps operating on a multi-app sensor may carry out security processes such as carrying out security monitoring (e.g., virus-scanning and/or monitoring for other security risks) and network monitoring. The apps may execute based on different respective configuration profiles 136 received through the overlay monitoring network 124. Such configuration profiles, for example, may include one or more lists (e.g., whitelist, blacklist) that specify what or what not to scan or monitor. Also, such configuration profiles may include behavior profiles corresponding to particular anomalies that may indicate a possible security breach/hack.

In example embodiments, passive apps may collect data from a single virtual MC (network interface card) of the multi-app sensor configured in a promiscuous mode. Active apps may be configured to only execute under the restrictions of an enforced configuration profile. During an active communication session, no outbound communication is allowed/possible from the multi-app sensor to the monitored control systems 120.

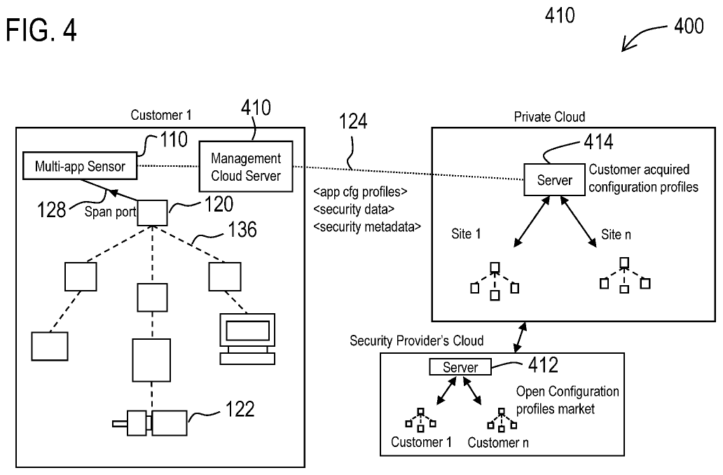

FIG. 4 illustrates a further view 400 of the described system. Data collected by the apps on the multi-app sensor 110 may be communicated to one or more cloud servers 410, 412, 414 on the monitoring network 124 and/or other multi-app sensors. Such cloud server may include a management cloud server 410 that manages multi-app sensors on an industrial network 208. The cloud servers may also include one or more security provider's cloud servers 412 that evaluate the data collected by the multi-app sensors. In addition, the cloud servers may include one or more private cloud servers 414 of one or more customers of the security providers for example.

Apps and cloud servers may use and/or create configuration profiles that are communicated through the monitoring network 124 between the cloud servers and multi-app sensors. Configuration profiles may be distributed for active communication (e.g., scanning). Any tested configuration profiles (profiles that do not negatively affect the system's availability or performance) with a given control system for any given security provider may be distributed to the security provider's cloud server 412 including metadata about the environment where the data was collected.

Configuration profiles may be distributed through the monitoring network in a bi-directional link using transliteration (deconstruction and reconstruction of the data file) from a management cloud server 410. Also, configuration profiles may be created based on empirical measurements on the connected networks that include: performance of the reference networks where the security profile was generated; and/or configuration restrictions applied during the execution of the security process.

In some embodiments, an app on a security provider's cloud server 412 may continuously evaluate the performance of multiple security providers for a given same security process to carry out cross-security provider vendor automated benchmarking. The generated benchmark data may be enriched with saved information from the configuration profiles and user provided data about the system in which the data was collected from.

In an example embodiment, configuration profiles may be automatically generated. For example, a combination of machine learning techniques may be used to derive the configuration profile used during the execution of an active security process. In some embodiments, configuration profiles may be implemented as XML, data. However, it should be appreciated that a configuration profile may have other formats and may correspond to any type of file, record, or other grouping of data that includes information capable controlling an application on a multi-app sensor in order to carry out security and/or network monitoring scanning and to detect control system anomalies.

In an example embodiment, closed loop model-based security monitoring (end-to-end) may be used. Such monitoring may include comparing a virtual model of the target automation system (e.g., a digital twin derived automatically from an initial profiling phase of a control system, or a security provider provided model with expected system behavior) with the production system behavior of the physical target system. Variables used for the profiling phase may include network information (network communication paths, throughput, protocols, etc.), control system node specific information (e.g., PLC in-memory read/write transactions in a timeline with other system activity), and regular endpoint security data (e.g., deployment of system processes, system process network activity, file system activity, etc.)

Based on this described monitoring, the system may autonomously generate further configuration profiles (e.g., virtual patches) capable of detecting such anomalies in other multi-app sensors. As illustrated in the following equation, for example, detected anomalous behavior at a given site is profiled to automatically derive a detection signature or model for other uncompromised systems by comparing the behavior of the reference model and the compromised system:

[Detection Model]=Σₖ₌₀ⁿ[Anomalous system behavior]−[Expected reference model behavior] where n=profiled security variable.

The described system may also carry out process variable correlation. For example, the multi-app sensor 110 may also host a process data collector app implemented with an OPC interface. The app would be responsible for defining and executing the process variable compression/sampling, depending on the configured system.

In addition, the system may carry out industrial data anonymization and obfuscation. For example, the multi-app sensor may include an optional app that when deployed will obfuscate the uploaded process data using simple obfuscation templates.

It should be appreciated that different apps on the multi-app sensor may be capable of saturating the computational resources of the multi-app sensor's hardware. Thus, an example embodiment of the system may employ continuous hardware-security performance optimization. For example, the multi-app sensor may be configured with an algorithm that balances the execution of each security process through time to ensure maximum security is obtained, while multiple processes execute on the single hardware of a particular multi-app sensor. This security performance works automatically as a closed loop to adjust not only a live parameter of the hypervisor resource allocation (e.g., memory and % CPU allocated to VM or process for application virtualization model), but also security configurations (e.g., more aggressive performance intensive scanning or monitoring) in order to control performance overhead of the multi-app sensor. It should also be appreciated that stand alone apps or apps running in dockers/containers may also regulated in this matter to control performance overhead.

The described system enables to fully instrument an industrial network with technology from top trusted security partners in a cost-effective way that minimizes deployment and the number of physical hardware sensors (thereby reducing network load and complexity). The described system allows for both on-premise and remote monitoring and management use cases. The described multi-app sensor provides an edge-to-private-cloud architecture that includes a virtualized environment where partner apps might reside together sharing the same hardware infrastructure while leveraging additional control for a distributed automated configuration and fine-grained configuration control for the different asset safety profiles. The system provides a managed services platform with both on-the-edge and on-the-cloud management (e.g., via Siemens MindSphere).

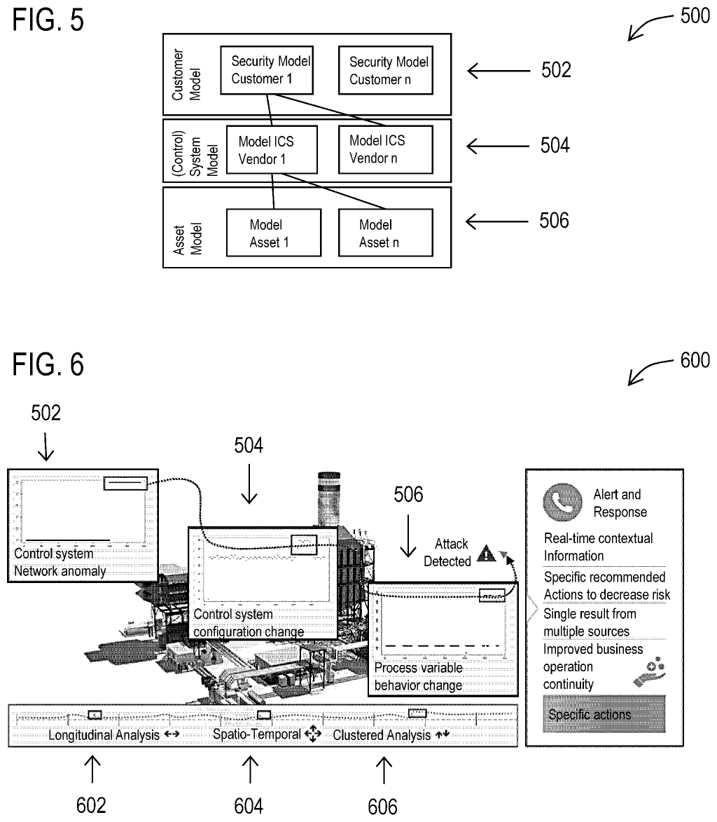

As illustrated in FIGS. 5 and 6, this achieves multi-dimensional security monitoring/modeling 500, 600 that can correlate in real time, network anomalies 502; multi-security provider control systems configuration changes; and asset vulnerabilities 506. In addition, information collected from each app may be contextualized and infused with threat intelligence to deliver OT monitoring as a service.

The example system may be configured to correlate security data from different security provider apps. For example, multi-dimensional (spatio-temporal) data correlation 604 may be performed to determine the anomaly from infused data from multiple data sources by each different apps (which may be from different security providers). Longitudinal analysis 602 may be performed through a sliding window over the temporal series and may include vertical cluster analysis 606 with correlation of security data points from at least three dimensions: control system's network 502, control system's configuration 504, and process control state 506 (through process variable decomposition and characterization). The first two dimensions may be analyzed using unsupervised and semi-supervised machine learning, while the last dimension may use supervised learning techniques. The analytical results may be used to generate the further configuration profiles (e.g., virtual patches) described previously.

Thus, (with reference to FIG. 1) the plurality of apps 108 operating in a common multi-app sensor 110 may collect data (from a physical control system 120 and a virtual model of the control system 120) that includes: control system network information; control system configuration information; and/or control system process variables. Based on comparisons between collected data from the control system and virtual model, the multi-app sensor may generate at least one further configuration profile that provides further detection coverage for control system anomalies. The multi-sensor app may then be configured to communicate the further configuration profile to further multi-app sensors over the overlay monitory network 124 (which may include one or more cloud servers facilitating the deployment of the further configuration profile and/or may include peer to peer communication of the further configuration profile between multi-app sensors).

Referring back to FIG. 4, in these described examples, a user-guided process and security data anonymization scheme may be performed at the edge (via the multi-app sensor 110), which provides information through the monitoring network 124 to enable big data analytics to be performed at a private security analytics cloud server 414. A specific anonymization app may be configured to control data exported from the multi-app sensor, which may offer a range of obfuscation and anonymization layers with pre-configured algorithms. In addition, multi-part computing techniques may be applied for cross-domain (IT-OT) provided data.

This described system may also include an open interface and development kit (e.g., an API library and associated documentation) that allows for integration of additional security apps. For example, the management cloud server 410 may provide an integration API for integration into an industrial network's asset configurations management tools.

The secure asset data collection from different control zones of the industrial network may be carried out through a direct or firewalled connection. With a direct or firewalled connection, a security agent (running on the multi-app sensor 110) may establish a one-way communication to the apps on the multi-app sensor 110 from control systems, uploading data periodically and sending change notifications to the management cloud server. The secure asset data collection may also be carried out through data-diode protected connection. A data-diode protected connection may include hardware with an internal data-diode/uni-directional gateway that prevents external connections by physically providing a one-way communication channel to the multi-app sensor 110.

The system may provide per-zone configuration of a multi-zone customer's industrial network. The system may also provide scheduled control of the level of intrusiveness and overhead for active scanners. In addition, the system may provide app downloads which update and replace preferred security provider apps and configurations.

It should also be appreciated that configuration profiles associated with the apps for one vendor may be extracted from a multi-app sensor and communicated to vendors with corresponding or similar apps, in order to improve the security and networking monitoring capabilities across multiple vendors. In further examples, the described system may include a marketplace server capable of communicating and charging fees for access to configuration profiles.

With these described features, hardware deployment costs may be reduced as many security processes can live in the same physical hardware. Also, the described features enable scalability of the security deployment (in terms of covered security processes) through an open ecosystem where apps can be updated and replaced. Further, the described system enables transparent monitoring through the deployment of data-diode protected or firewalled multi-app sensors that connect to each other through the separate overlay monitoring network. With this described arrangement, the system may achieve enhanced detection through the data enrichment of the collected security data from process control data and process semantics information. Further, the described edge-to-cloud model-based detection where models may be derived automatically from real connected systems from multiple different security providers. In addition, the described system may facilitate autonomous generation of further configuration profiles (e.g., virtual patches) that provide detection coverage while security fixes are under development. Also, collection of complete device data and configurations may be carried out down to level 0 devices. Further security data may be correlated across different security provider apps.

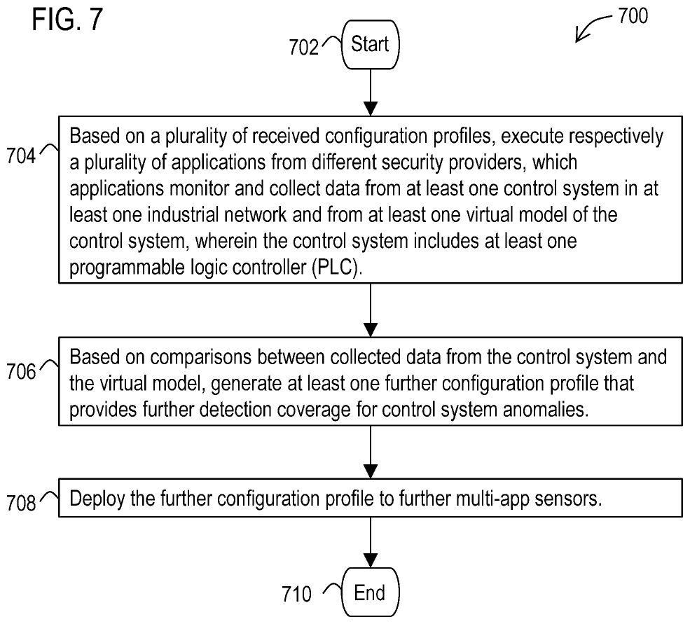

Referring now to FIG. 7, a methodology 700 is illustrated that facilitates this described industrial security lifecycle management. While the methodology is described as being a series of acts that are performed in a sequence, it is to be understood that the methodology may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The methodology may start at 702 and may include several acts carried out through operation of at least one processor in the multi-app sensor. These acts may include an act 704 of based on a plurality of received configuration profiles, executing respectively a plurality of applications from different security providers, which applications monitor and collect data from at least one control system in at least one industrial network and from at least one virtual model of the control system, wherein the control system includes at least one programmable logic controller (PLC). The methodology may also include based on comparisons between collected data from the control system and the virtual model, an act 706 of generating at least one further configuration profile that provides further detection coverage for control system anomalies. In addition, the methodology may include an act 708 of deploying the further configuration profile to further multi-app sensors. At 710 the methodology may end.

Also, it should be appreciated that this described methodology may include additional acts and/or alternative acts corresponding to the features described previously with respect to the system 100.

For example, the described applications may carry out security monitoring and network monitoring. Also, the configuration profiles may include at least one of: a list that specifies what or what not to scan or monitor; behavior profiles corresponding to anomalies; or any combination thereof.

In addition, at least some of the applications from different security providers may respectively operate in respective different virtual machines on the multi-app sensor. Also, in some embodiments the multi-app sensor may automatically adjust live parameters of a hypervisor resource allocation to each virtual machine to regulate data collection and monitoring operations of the applications in order to control performance overhead of the multi-app sensor. Also, in some examples the multi-app sensor may include a virtual machine with a virtual network interface card in a promiscuous mode configured to capture the collected data.

Furthermore, the multi-app sensor may include a store-and-forward service configured to communicate collected data to the at least one cloud server. In example embodiments, the collected data may include control system network information; control system configuration information; and control system process variables. For example, the control system configuration information may include PLC in-memory read/write transactions.

Also, the multi-app sensor may include a data diode that prevents outbound communications to the control systems. Further, the multi-app sensor may generate the virtual model of the control system based on collected data.

Furthermore, the methodology may include an act of at least one cloud server receiving collected data from a plurality of multi-app sensors collected by applications from different security providers. The cloud server may further distribute the configuration profiles to a plurality of multi-app sensors.

In addition, the cloud server may generate benchmarking data comparing the applications from the different security providers. The multi-app sensor may anonymize and obfuscate collected data communicated to the at least one cloud server.

It should be appreciated that acts associated with the above-described methodologies, features, and functions (other than any described manual acts) may be carried out by one or more data processing systems (multi-app sensor 110 and cloud servers 126) via operation of at least one processor 102. As used herein a processor corresponds to any electronic device that is configured via hardware circuits, software, and/or firmware to process data. For example, processors described herein may correspond to one or more (or a combination) of a microprocessor, CPU, or any other integrated circuit (IC) or other type of circuit that is capable of processing data in a data processing system. As discuss previously, the processor that is described or claimed as being configured to carry out a particular described/claimed process or function may correspond to a CPU that executes computer/processor executable instructions 106 stored in a memory 104 in the form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function.

In addition, it should also be understood that a processor that is described or claimed as being configured to carry out a particular described/claimed process or function may correspond to the combination of the processor 102 with the executable instructions 106 (e.g., software/firmware apps.) loaded/installed into the described memory 104 (volatile and/or non-volatile), which are currently being executed and/or are available to be executed by the processor to cause the processor to carry out the described/claimed process or function. Thus, a processor that is powered off or is executing other software, but has the described software installed on a data store in operative connection therewith (such as on a hard drive or SSD) in a manner that is setup to be executed by the processor (when started by a user, hardware and/or other software), may also correspond to the described/claimed processor that is configured to carry out the particular processes and functions described/claimed herein.

Further the phrase “at least one” before an element (e.g., a processor) that is configured to carry out more than one function/process may correspond to one or more elements (e.g., processors) that each carry out the functions/processes and may also correspond to two or more of the elements (e.g., processors) that respectively carry out different ones of the one or more different functions/processes. In addition, it should be understood, that reference to “a processor” may include multiple physical processors or cores that are configures to carry out the functions described herein. In addition, it should be appreciated that a data processing system may also be referred to as a controller that is operative to control at least one operation.

It is also important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions 106 (e.g., software and/or firmware instructions 108) contained within a data store 118 that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C#, C++ or any other form of code that can be programmed/configured to cause at least one processor to carry out the acts and features described herein. Still further, results of the described/claimed processes or functions may be stored in a computer-readable medium, displayed on a display device, and/or the like.

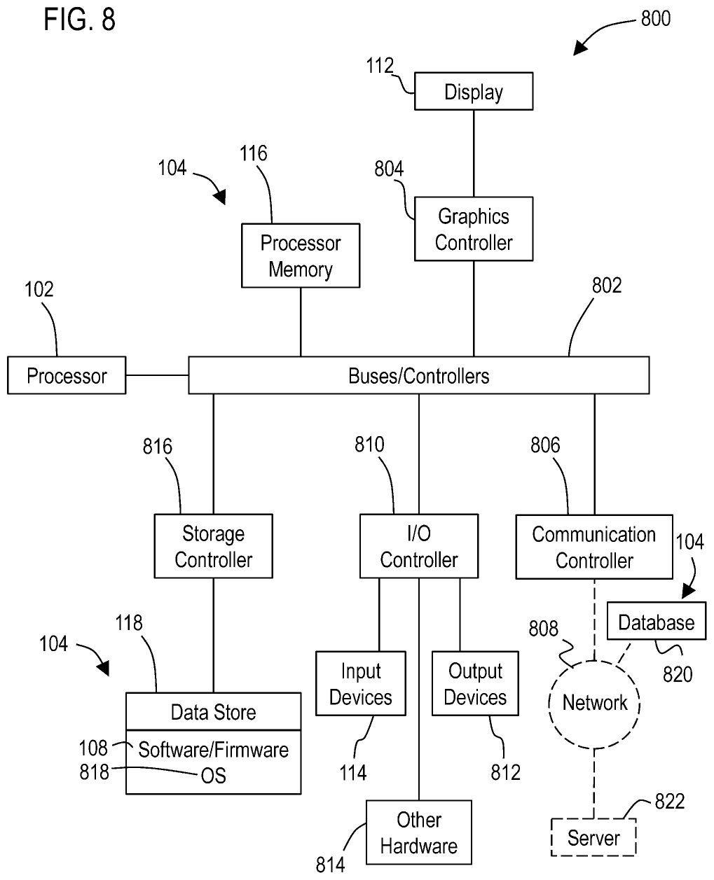

FIG. 8 illustrates a further example of a data processing system 800 with which one or more embodiments of the multi-app sensor 110 or the cloud servers may be implemented. For example, in some embodiments, the at least one processor 102 (e.g., a CPU) may be connected to one or more bridges/controllers/buses 802 (e.g., a north bridge, a south bridge). One of the buses for example, may include one or more I/O buses such as a PCI Express bus. Also connected to various buses in the depicted example may include the processor memory 116 (e.g., RAM) and a graphics controller 804. The graphics controller 804 may generate a video signal that drives the display device 112. It should also be noted that the processor 102 in the form of a CPU may include a memory therein such as a CPU cache memory. Further, in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 806 (Ethernet controllers, WiFi controllers, cellular controllers) operative to connect to a network 808 such as a local area network (LAN), Wide Area Network (WAN), the Internet, a cellular network, and/or any other wired or wireless networks or communication equipment.

Further components connected to various busses may include one or more I/O controllers 810 such as USB controllers, Bluetooth controllers, and/or dedicated audio controllers (connected to speakers and/or microphones). It should also be appreciated that various peripherals may be connected to the I/O controller(s) (via various ports and connections) including the input devices 114, output devices 812 (e.g., printers, speakers) or any other type of device that is operative to provide inputs to and/or receive outputs from the data processing system.

Also, it should be appreciated that many devices referred to as input devices or output devices may both provide inputs and receive outputs of communications with the data processing system. For example, the processor 102 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 814 connected to the I/O controllers 810 may include any type of device, machine, sensor, or component that is configured to communicate with a data processing system.

Additional components connected to various busses may include one or more storage controllers 816 (e.g., SATA). A storage controller may be connected to a storage device data store 118 such as one or more storage drives and/or any associated removable media. Also, in some examples, a data store such as an NVMe M.2 SSD may be connected directly to an I/O bus 802 such as a PCI Express bus.

A data processing system in accordance with an embodiment of the present disclosure may include an operating system 818. Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, macOS, and Android operating systems.

The data processing system 800 may also include or be operative to communicate with one or more data stores 104 that correspond to databases 820. The processor 102 may be configured to manage, retrieve, generate, use, revise, and store data, executable instructions, and/or other information described herein from/in the database 820. Examples of a data database may include a file and/or a record stored in a relational database (e.g., Oracle, Microsoft SQL Server), which may be executed by the processor 102 or may execute in a second data processing system connected via a network 808.

It should be understood that the data processing system 800 may directly or over the network 808 with one or more other data processing systems such as a server 822 (which may in combination correspond to a larger data processing system). For example, a larger data processing system may correspond to a plurality of smaller data processing systems implemented as part of a distributed system in which processors associated with several smaller data processing systems may be in communication by way of one or more network connections and may collectively perform tasks described as being performed by a single larger data processing system. Thus, it is to be understood that when referring to a data processing system, such a system may be implemented across several data processing systems organized in a distributed system in communication with each other via a network.

In addition, it should be appreciated that data processing systems may include virtual machines in a virtual machine architecture or cloud environment that execute the executable instructions. For example, the processor and associated components may correspond to the combination of one or more virtual machine processors of a virtual machine operating in one or more physical processors of a physical data processing system. Examples of virtual machine architectures include VMware ESCi, Microsoft Hyper-V, Xen, and KVM. Further, the described executable instructions may be bundled as a container that is executable in a containerization environment such as Docker.

Also, it should be noted that the processor described herein may correspond to a remote processor located in a data processing system such as a server that is remote from the display and input devices described herein. In such an example, the described display device and input device may be included in a client data processing system (which may have its own processor) that communicates with the server (which includes the remote processor) through a wired or wireless network (which may include the Internet). In some embodiments, such a client data processing system, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In another example, such a client data processing system may execute a web browser or thin client application. Inputs from the user may be transmitted from the web browser or thin client application to be evaluated on the server, rendered by the server, and an image (or series of images) sent back to the client data processing system to be displayed by the web browser or thin client application. Also, in some examples, the remote processor described herein may correspond to a combination of a virtual processor of a virtual machine executing in a physical processor of the server.

Those of ordinary skill in the art will appreciate that the hardware and software depicted for the data processing system may vary for particular implementations. The depicted examples are provided for the purpose of explanation only and is not meant to imply architectural limitations with respect to the present disclosure. Also, those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 800 may conform to any of the various current implementations and practices known in the art.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. An industrial security lifecycle management hub system comprising:
at least one multi-app sensor comprising at least one processor configured via executable instructions included in at least one memory to:
based on a plurality of received configuration profiles, execute respectively a plurality of applications from different security providers, which applications monitor and collect data from at least one control system in at least one industrial network and from at least one virtual model of the control system, wherein the control system includes at least one programmable logic controller;
based on comparisons between collected data from the control system and the virtual model, generate at least one further configuration profile that provides further detection coverage for control system anomalies; and
deploy the further configuration profile to further multi-app sensors.

2-10. (canceled)

11. A method for carrying out industrial security lifecycle management comprising:
through operation of at least one processor in at least one multi-app sensor:
based on a plurality of received configuration profiles, executing respectively a plurality of applications from different security providers, which applications monitor and collect data from at least one control system in at least one industrial network and from at least one virtual model of the control system, wherein the control system includes at least one programmable logic controller (PLC);
based on comparisons between collected data from the control system and the virtual model, generating at least one further configuration profile that provides further detection coverage for control system anomalies; and
deploying the further configuration profile to further multi-app sensors.

12. The method according to claim 11, wherein the applications carry out security monitoring and network monitoring, wherein the configuration profiles include at least one of: a list that specifies what or what not to scan or monitor; behavior profiles corresponding to anomalies; or any combination thereof.

13. The method according to claim 11, wherein at least some of the applications from different security providers respectively operate in respective different virtual machines on the multi-app sensor, further comprising the multi-app sensor automatically adjusting at least one live parameter of a hypervisor resource allocation to at least one virtual machine in order to control performance overhead of the multi-app sensor.

14. The method according to claim 13, wherein the multi-app sensor includes a virtual machine with a virtual network interface card in a promiscuous mode configured to capture the collected data.

15. The method according to claim 11, wherein the multi-app sensor includes a store-and-forward service configured to communicate collected data to the at least one cloud server, wherein the collected data includes: control system network information; control system configuration information; and control system process variables, wherein the control system configuration information includes PLC in-memory read/write transactions.

16. The method according to claim 11, wherein the multi-app sensor includes a data diode that prevents outbound communications to the control system.

17-19. (canceled)

20. A non-transitory computer readable medium encoded with processor executable instructions that when executed by at least one processor, cause the at least one processor to carry out a method according to claim 11.

21. The system according to claim 1, wherein an active app operates on a multi-app sensor, wherein the active app executes based on a configuration profile, wherein the active app is configured to only execute under the restrictions of an enforced configuration profile.

22. The system according to claim 1, wherein the multi-app sensor contains multiple virtual machines and a hypervisor resource allocation to each virtual machine, wherein the multi-app sensor automatically adjusts live parameters of a hypervisor resource allocation to each virtual machine and security configurations of the applications to regulate data collection and monitoring operations of the applications.

23. The system according to claim 1, wherein the system is adapted to autonomously generate virtual patches capable of detecting such anomalies in other multi-app sensors, wherein the virtual patch is a configuration profile.

24. The system according to claim 1, wherein the applications carry out security monitoring and network monitoring, wherein the configuration profiles include at least one of:
a list that specifies what or what not to scan or monitor;
behavior profiles corresponding to anomalies; or
any combination thereof.

25. The system according to claim 1, wherein at least some of the applications from different security providers respectively operate in respective different virtual machines on the multi-app sensor, further comprising the multi-app sensor automatically adjusting at least one live parameter of a hypervisor resource allocation to at least one virtual machine in order to control performance overhead of the multi-app sensor.

26. The system according to claim 1, wherein the multi-app sensor includes a virtual machine with a virtual network interface card in a promiscuous mode configured to capture the collected data.

27. The system according to claim 1, wherein the multi-app sensor includes a store-and-forward service configured to communicate collected data to the at least one cloud server, wherein the collected data includes: control system network information; control system configuration information; and control system process variables.

28. The system according to claim 1, wherein the control system configuration information includes PLC in-memory read/write transactions.

29. The system according to claim 1, wherein the multi-app sensor includes a data diode that prevents outbound communications to the control systems.

30. The system according to claim 1, wherein the multi-app sensor is configured to generate the virtual model of the control system based on collected data.

31. The system according to claim 1, further comprising at least one cloud server that receives collected data from a plurality of multi-app sensors collected by applications from different security providers and distributes the configuration profiles to a plurality of multi-app sensors.

32. The system according to claim 31, wherein the plurality of multi-app sensors from which collected data is received are configured to anonymize and obfuscate collected data communicated to the at least one cloud server, wherein the at least one cloud server is further configured to generate and output benchmarking data comparing the applications from the different security providers.
